(19) United States
(12) Patent Application Publication
(10) Pub. No.: US 2025/0217833 A1
(43) Pub. Date: Jul. 3, 2025

(54) CHARGING FACILITY GUIDANCE DEVICE AND CHARGING FACILITY GUIDANCE METHOD

(71) Applicant: HONDA MOTOR CO., LTD., Tokyo (JP)

(72) Inventor: Kei HIROHATA, Tokyo (JP)

(21) Appl. No.: 18/841,686

(22) PCT Filed: Dec. 12, 2022
(86) PCT No.: PCT/JP2022/045724

§ 371 Date: Aug. 27, 2024

(30) Foreign Application Priority Data
Feb. 28, 2022 (JP) 2022-029286

(51) Int. Cl. G06Q 30/0207; G01C 21/34; G01C 21/36; G06Q 10/02

(52) U.S. Cl. CPC G06Q 30/0207; G01C 21/3469; G01C 21/3682; G01C 21/3697; G06Q 10/02

(57) ABSTRACT

A charging facility guidance device 30 comprises: a guidance request input unit 311 that stores charging facility information relating to charging facilities for charging a vehicle, and identification information and battery capacity information relating to a plurality of vehicles, and receives information for requesting guidance on charging facilities from the vehicle side; a charging facility retrieval unit 312 that retrieves charging facilities on the basis of information on the position of the vehicle; a benefit information creation unit 313 that uses charging facility information relating to the retrieved charging facilities and battery capacity information relating to the vehicle to create information on benefits to be given to the vehicle by the charging facilities; and a benefit information output unit 314 that transmits the charging facility information and the benefit information to the vehicle side.

### TECHNICAL FIELD

The present invention relates to a charging facility suggestion device and a charging facility suggestion method for suggesting a charging facility to a user of an electric vehicle.

### BACKGROUND ART

Currently, electric vehicles, especially battery electric vehicles (BEVs), are becoming increasingly popular, and there are different types of vehicles having battery capacities of various sizes. A larger battery capacity in an electric vehicle leads to a longer driving range, thereby enhancing convenience for the user. However, the larger battery capacity increases the weight of the battery, which increases the vehicle weight and the energy required to move the vehicle. Greater energy is required to manufacture vehicles having larger battery capacities. That is to say, vehicles having larger battery capacities generally have higher environmental burden than vehicles having smaller battery capacities. Vehicles having large battery capacities require high-performance charging facilities because of the large amount of charging required. For example, Patent Document 1 (Japanese Patent No. 4985748) discloses a system that utilizes a plurality of types of chargers different in charging performance for respective parking spaces, and thus reduces the maximum capacity of a power source to which all of the chargers are connected. Specifically, Patent Document 1 discloses a technique for assigning one of the plurality of types of chargers to an arriving electric vehicle based on the need for charging or the ease of charging of the vehicle.

### CITATION LIST

### Patent Document

Patent Document 1: Japanese Patent No. 4985748

### DISCLOSURE OF THE INVENTION

### Problems to be Solved by the Invention

However, in the system disclosed in Patent Document 1, a vehicle having a large charge capacity is determined to have a high need for charging, and thus ends up being assigned a high-performance charger. This trend leads users to choose electric vehicles having larger battery capacities, raising a concern about an increase in environmental burden on society as a whole. It has been reported that a large number of users (for example, 90%) are estimated to mainly drive within the city with a daily travel distance of 90 km or less and make occasional long-distance driving. For such users, an electric vehicle having a charge capacity of 36 kWh, for example, can be fully charged in 12 hours through charging at home (standard charging) at night, and even after a short drive, can be fully charged through standard charging (3 kW). By simple calculation, a vehicle having a charge capacity of 36 kWh can travel approximately 270 km on the assumption that the energy consumption (Wh/km) for the vehicle to travel 1 km is 130 Wh/km. For a user who mainly drives a vehicle within the city with a daily travel distance of 90 km or less, for example, standard charging at a standard charging station is sufficient to fill the vehicle after a short drive. High-performance chargers (for example, a fast charger having an output of 50 kW) are only installed mainly in large-scale facilities and public facilities such as SAs/PAs because of significant investment required for such facilities. Standard chargers (for example, those having an output of 3 kW) are inexpensive but tend to be used less frequently, discouraging installation of standard chargers. The service life of charging stations are said to be approximately eight years, and charging stations installed in the early 2010s have reached the end of their service life. For this reason, combined with the slow spread of electric vehicles, some of such charging stations are abandoned. It is therefore desirable to promote the spread of electric vehicles that are designed with consideration for environmental burden on society as a whole, that target users who mainly drive within the city, and that have smaller battery capacities, as well as the spread of charging facilities suitable for such electric vehicles.

The present invention was achieved in consideration of the above-described circumstances, and an object thereof is to provide a charging facility suggestion device that makes it possible to promote the spread of electric vehicles that are designed with consideration for environmental burden on society as a whole, that target users who mainly drive within the city, and that have smaller battery capacities, as well as the spread of charging facilities suitable for such electric vehicles.

### Means for Solving the Problems

(1) A charging facility suggestion device (for example, a “charging facility suggestion device 30” described below) according to the present invention includes: a map information storage (for example, a “map information storage 321” described below) configured to store charging facility information pertaining to charging facilities for charging vehicles; a vehicle information storage (for example, a “vehicle information storage 322” described below) configured to store identification information and battery capacity information of a plurality of vehicles; a suggestion request input unit (for example, an “suggestion request input unit 311” described below) configured to receive, from a vehicle (for example, a “vehicle 50” described below) included in the plurality of vehicles or a terminal (for example, an “in-vehicle navigation device 10” or a “portable terminal 20” described below) of a user of the vehicle, suggestion request information including position information of the vehicle and a charging facility suggestion request; a charging facility search unit (for example, a “charging facility search unit 312” described below) configured to search for charging facilities located within a predetermined range from a position of the vehicle among the charging facilities based on the position information of the vehicle included in the suggestion request information; an incentive information creation unit (for example, an “incentive information creation unit 313” described below) configured to create, based on the charging facility information pertaining to charging facilities found by the charging facility search unit and the battery capacity information of the vehicle corresponding to the identification information of the vehicle, incentive information of each of the found charging facilities for the vehicle; and an incentive information output unit (for example, an “incentive information output unit 314” described below) configured to transmit the charging facility information and the incentive information to the vehicle or the terminal of the user of the vehicle.

According to (1), a charging facility suggestion device can be provided that makes it possible to promote the spread of electric vehicles designed with consideration for environmental burden on society as a whole as well as the spread of charging facilities.

(2) Upon receiving the charging facility suggestion request from two or more of the vehicles or terminals (for example, the “in-vehicle navigation device 10” or the “portable terminal 20” described below) of users of the vehicles, the incentive information creation unit (for example, the “incentive information creation unit 313” described below) described in (1) may create incentive information so as to benefit a vehicle having a smaller battery capacity according to the battery capacity indicated by the battery capacity information of each vehicle.

According to (2), it is possible to promote the spread of electric vehicles that are designed with greater consideration for environmental burden on society as a whole and that have smaller battery capacities.

(3) The incentive information creation unit (for example, the “incentive information creation unit 313” described below) of the charging facility suggestion device (for example, the “charging facility suggestion device 30” described below) described in (1) or (2) may create the incentive information as a priority reservation for the charging facility or a discount on a unit charging price.

According to (3), it is possible to promote the spread of electric vehicles that are designed with greater consideration for environmental burden on society as a whole and that have smaller battery capacities.

(4) In the charging facility suggestion device (for example, the “charging facility suggestion device 30” described below) described in any one of (1) to (3), the charging facility information in the map information storage (for example, the “map information storage 321” described below) may include charging speed information of the charging facilities, and the incentive information creation unit (for example, the “incentive information creation unit 313” described below) may create the incentive information for any of the charging facilities that has charging speed information indicating a lower charging speed than a predetermined value.

According to (4), it is possible to promote the spread of standard chargers designed with greater consideration for environmental burden on society as a whole.

(5) A charging facility suggestion method according to the present invention is a charging facility suggestion method for suggesting a charging facility. The charging facility suggestion method includes implementation by a computer of: a map information storage step of storing charging facility information pertaining to charging facilities for charging vehicles; a vehicle information storage step of storing identification information and battery capacity information of a plurality of vehicles; a suggestion request input step of receiving, from a vehicle included in the plurality of vehicles or a terminal (for example, the “in-vehicle navigation device 10” or the “portable terminal 20” described below) of a user of the vehicle, suggestion request information including position information of the vehicle and a charging facility suggestion request; a charging facility search step of searching for charging facilities located within a predetermined range from a position of the vehicle among the charging facilities based on the position information of the vehicle included in the suggestion request information; an incentive information creation step of creating, based on the charging facility information pertaining to charging facilities found in the charging facility search step and the battery capacity information of the vehicle corresponding to the identification information of the vehicle, incentive information of each of the found charging facilities for the vehicle; and an incentive information output step of transmitting the charging facility information and the incentive information to the vehicle or the terminal of the user of the vehicle.

The method described in (5) produces the same effects as the charging facility suggestion device described in (1).

### Effects of the Invention

The present invention makes it possible to promote the spread of electric vehicles designed with consideration for environmental burden on society as a whole as well as the spread of charging facilities.

### BRIEF DESCRIPTION OF THE DRAWINGS

FIG. 1 is a block diagram illustrating a basic overall configuration of a charging facility suggestion system according to an embodiment of the present invention; FIG. 2 is a functional block diagram illustrating a functional configuration of an in-vehicle navigation device according to the embodiment of the present invention; FIG. 3 is a functional block diagram illustrating a functional configuration of a portable terminal according to the embodiment of the present invention; FIG. 4 is a functional block diagram illustrating a functional configuration of a charging facility suggestion device according to the embodiment of the present invention; FIG. 5 is a functional block diagram illustrating a functional configuration of a charging facility information processing device according to the embodiment of the present invention; and

FIG. 6 is a flowchart showing basic operation of the charging facility suggestion device according to the embodiment of the present invention.

### PREFERRED MODE FOR CARRYING OUT THE INVENTION

### Overall Configuration of Charging Facility Suggestion System 1

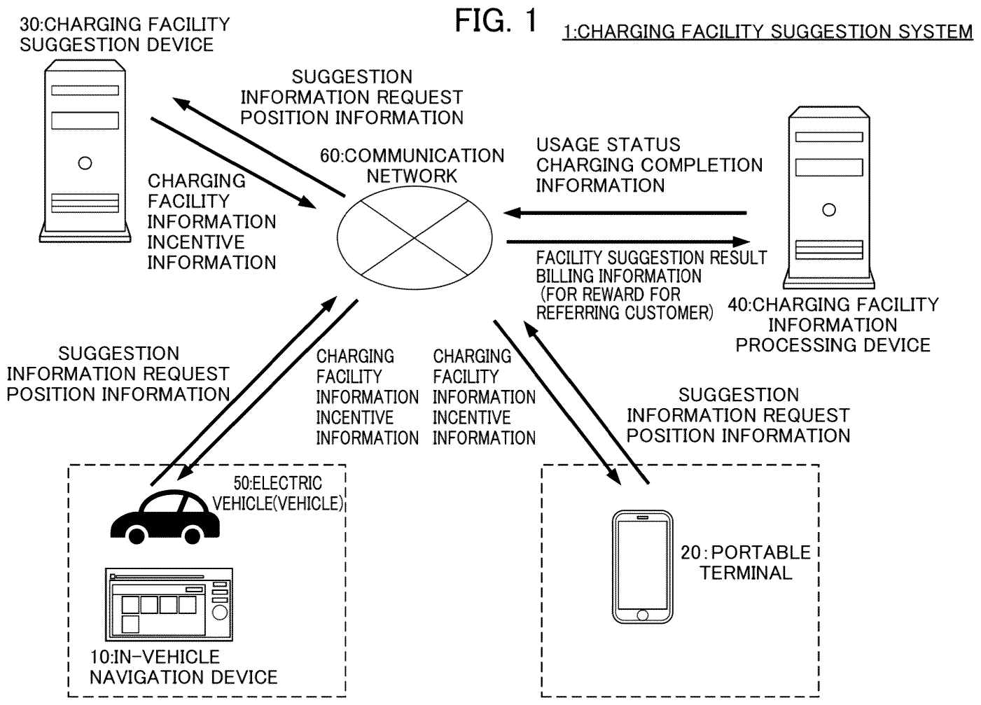

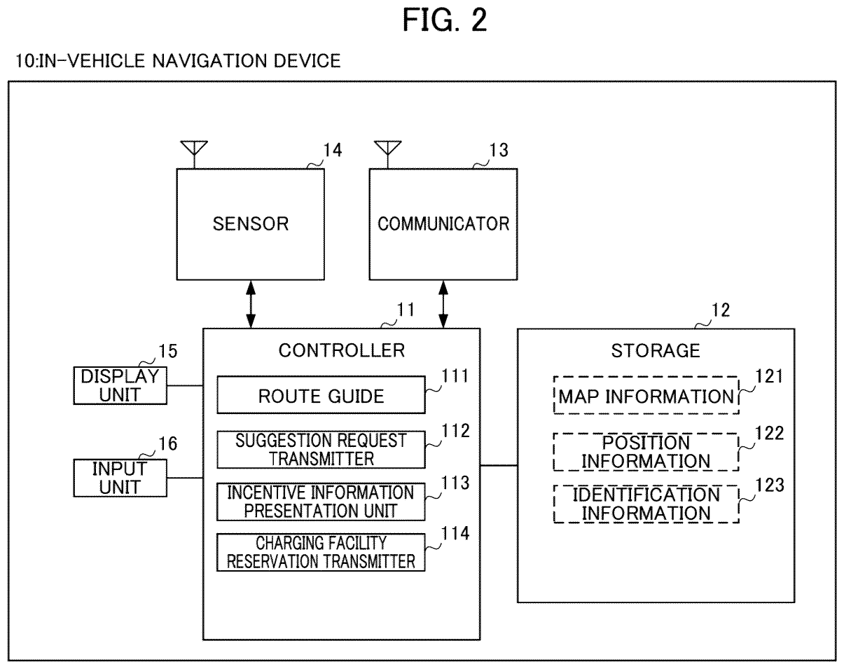

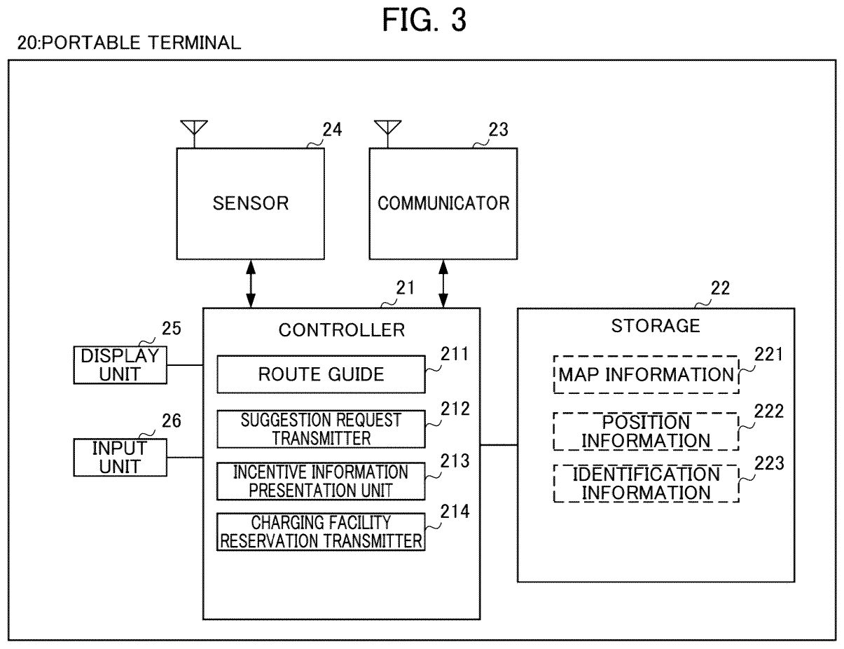

The following describes a charging facility suggestion system according to a preferred embodiment of the present invention in detail with reference to the drawings. FIG. 1 illustrates an overall configuration of a charging facility suggestion system 1.

As shown in FIG. 1, the charging facility suggestion system 1 includes an in-vehicle navigation device 10 mounted in an electric vehicle 50, a portable terminal 20, a charging facility suggestion device 30, the vehicle 50, and a charging facility information processing device 40. In the present embodiment, unless otherwise noted, a battery electric vehicle (BEV) is also referred to simply as an electric vehicle, an electrically powered vehicle, or a vehicle. The devices and terminals are communicatively connected to each other via a communication network 60. FIG. 1 also shows information that is transmitted and received by the devices and terminals. However, the information shown is only an example. Information other than that shown in FIG. 1 may be transmitted and received in the present embodiment.

The in-vehicle navigation device 10 has a positioning function of obtaining position information of the in-vehicle navigation device 10 (i.e., position information of the vehicle 50). The position information obtained by the in-vehicle navigation device 10 is transmitted to the charging facility suggestion device 30 together with identification information of the vehicle 50 when, for example, a suggestion information request for requesting suggestion of a charging facility is transmitted to the charging facility suggestion device 30. Furthermore, the in-vehicle navigation device 10 has a function of suggesting, to a user on board the vehicle 50, a charging facility that is located within a predetermined range from the position of the vehicle and that offers incentive information to the vehicle as charging facility information provided using the charging facility suggestion system 1. The in-vehicle navigation device 10 may display the charging facility information and provide, for example, route guidance from the current position to the specified charging facility that offers the incentive information.

The portable terminal 20 refers to a portable terminal of the user of the vehicle 50. Preferably, the portable terminal 20 has application software installed to work with the vehicle 50 that is used by the user. The portable terminal 20 may be equipped with the same functions as the in-vehicle navigation device 10. The portable terminal 20 can acquire identification information and position information of the vehicle 50. Like the in-vehicle navigation device 10, the portable terminal 20 also transmits the position information of the vehicle 50 together with the identification information of the vehicle 50 to the charging facility suggestion device 30 when transmitting thereto a suggestion information request for requesting suggestion of a charging facility. The portable terminal 20 can be implemented by a smartphone, a cell phone, a tablet terminal, a notebook computer, or any other portable electronic device. The user can communicate with the charging facility suggestion device 30 via the in-vehicle navigation device 10 mounted in the vehicle 50 or via the user's portable terminal 20. In the present embodiment, the user can send and receive data to and from the charging facility suggestion device 30 via the vehicle 50 or the portable terminal 20. As such, the vehicle 50 or the portable terminal 20 of the user of the vehicle 50 can be recognized as “communication with the vehicle side” from the perspective of the charging facility suggestion device 30. In the present embodiment, unless otherwise noted, “the vehicle 50 or the portable terminal 20 of the user of the vehicle” is also referred to as “vehicle side”.

In response to a charging facility suggestion request from the vehicle side, the charging facility suggestion device 30 creates, as a process specific to the present embodiment, incentive information of a charging facility for the vehicle based on battery capacity information of the vehicle and charging facility information pertaining to the charging facility. The charging facility suggestion device 30 can be, for example, implemented by incorporating software specific to the present embodiment into a general-purpose server device. The server device herein may be a single computer or a distributed system including a plurality of computers.

The charging facility information processing device 40 is, for example, provided for each charging facility, and manages the usage status of each charging apparatus provided at the charging facility. Examples of the usage status of a charger (charging apparatus) include “in use” (charging a vehicle), “available”, “reserved”, and “not reserved”. Each charging facility information processing device 40 reports the usage status of the charging apparatus provided at the corresponding charging facility to the charging facility suggestion device 30 periodically or upon request. It should be noted that the present invention may have a configuration in which a charging facility information processing device 40 manages the usage status for a plurality of charging facilities. Upon the vehicle side selecting, as a charging location, a charging apparatus provided at a charging facility that offers incentive information and that has been outputted from the charging facility suggestion device 30, the charging facility information processing device 40 receives, from the charging facility suggestion device 30, information pertaining to the vehicle intending to use this charging facility (also referred to as a “facility suggestion result”). Thus, the charging facility information processing device 40 places the charging apparatus at the charging facility into a reserved state. Upon the vehicle 50 completing charging using the charging apparatus at the charging facility suggested by the charging facility suggestion device 30, the charging facility information processing device 40 notifies the charging facility suggestion device 30 that the vehicle 50 has completed charging using the charging apparatus. In response, for example, the charging facility suggestion device 30 can create billing information (for a reward for referring a customer) for the charging facility and transmit the billing information to the charging facility information processing device 40. The charging facility information processing device 40 can then process the reward for referring a customer.

As described above, the vehicle 50 is equipped with the in-vehicle navigation device 10 and is capable of communicating with the charging facility suggestion device 30.

The communication network 60 is implemented by a network such as the Internet or a cellular phone network, or a combination of these networks. The overall configuration of the charging facility suggestion system 1 has been described above. The following describes configurations of the devices and terminals.

### Functional Blocks of In-Vehicle Navigation Device 10

Functional blocks of the in-vehicle navigation device 10 will be described with reference to the block diagram in FIG. 2. As shown in FIG. 2, the in-vehicle navigation device 10 includes a controller 11, a storage 12, a communicator 13, a sensor 14, a display 15, and an input unit 16.

The controller 11 includes an arithmetic processor such as a microprocessor and controls components of the in-vehicle navigation device 10. Details of the controller 11 are described below.

The storage 12 includes, for example, semiconductor memory. The storage 12 stores: a control program, which is referred to as firmware or an operating system; a program for executing a function of transmitting a suggestion information request, which is a request for the charging facility suggestion device 30 to suggest a charging facility to a vehicle 50, receiving from the charging facility suggestion device 30 incentive information of charging facilities that are located within a predetermined range from the position of the vehicle 50 and contained in a set of charging facility information, displaying the charging facilities, and transmitting, for example, a reservation request to the charging facility suggestion device 30 upon one of the displayed charging facilities (charging apparatuses) being selected; and various other information such as map information. FIG. 2 shows map information (navigation map) 121, position information 122, and identification information 123 as information stored in the storage 12.

The map information (navigation map) 121 is, for example, used for navigation and represents roads with nodes and links. The position information 122 is information containing the position of the in-vehicle navigation device 10 (i.e., information containing the position of the vehicle 50) measured through positioning performed by the sensor 14. Besides the measured position, the position information 122 also contains a positioning time, which is the time of the positioning performed. The identification information 123 is used for identifying the vehicle 50, and contains an identification ID that uniquely identifies the vehicle, vehicle name information and/or vehicle model information. The position information 122 and the identification information 123 are transmitted when a suggestion information request, which is a request for the charging facility suggestion device 30 to suggest a charging facility, is transmitted. As described below, the battery capacity of the vehicle is uniquely associated with the vehicle name information and/or the vehicle model information, and the charging facility suggestion device 30 can calculate the battery capacity of the vehicle based on the suggestion information request.

The communicator 13 has, for example, a DSP and implements wireless or wired communication between the in-vehicle navigation device 10 and other devices (for example, the charging facility suggestion device 30) and the vehicle side via the communication network 60 in accordance with a standard such as Long Term Evolution (LTE), 4th Generation (4G), 5th Generation (5G), or Wi-Fi (registered trademark). The communicator 13 is, for example, used to transmit data such as a connection request from the vehicle side, the position information of the vehicle, and the suggestion request information, or conversely to receive charging facility information pertaining to charging facilities that offer incentive information. However, no particular limitations are placed on the data to be transmitted and received between the communicator 13 and other devices, and any other information may be transmitted and received.

The sensor 14 includes, for example, a global positioning system (GPS) sensor, a gyroscope sensor, and an acceleration sensor. The sensor 14 functions as a position detector that detects position information and receives a GPS satellite signal using the GPS sensor to determine the position information (latitude and longitude) of the in-vehicle navigation device 10.

The display unit 15 includes a display device such as a liquid crystal display or an organic electroluminescent panel. The display 15 displays an image upon receiving an instruction from the controller 11. The display unit 15 displays, for example, information such as various user interfaces and charging facility information containing charging facilities that are located within a predetermined range from the position of the vehicle, that offer incentive information, and that have been outputted form the charging facility suggestion device 30.

The input unit 16 includes, for example, physical switches referred to as a numeric keypad and an input device (not shown) such as a touch panel disposed over a display surface of the display unit 15. A user's selection operation, for example, is implemented by outputting a signal to the controller 11 based on input of an operation from the input unit 16 through, for example, the user pressing the numeric keypad or touching the touch panel.

It should be noted that the in-vehicle navigation device 10 may further include, for example, a speaker and a microphone, not shown. In this case, information can be outputted from the speaker as sound, and the driver's various selections and instructions can be inputted to the controller 11 by sound input through the microphone using voice recognition technology.

Next, the details of the controller 11 will be described. The controller 11 includes a microprocessor having, for example, a central processing unit (CPU), random access memory (RAM), read only memory (ROM), and input/output (I/O) capabilities. The CPU executes each program read from the ROM or the storage 12 by reading information from the RAM, the ROM, and the storage 12 during the execution, writes information to the RAM and the storage 12, and exchanges signals with the communicator 13, the sensor 14, the display unit 15, and the input unit 16. In this way, hardware and software (program) cooperate with each other to implement processing in the present embodiment.

The controller 11 includes, as functional blocks, a route guide 111, a suggestion request transmitter 112, an incentive information presentation unit 113, and a charging facility reservation transmitter 114.

The route guide 111 performs processing for route guidance to a destination such as a general facility inputted or selected by the user. The processing for route guidance to a destination is equivalent to processing for route guidance in a general car navigation system, and is a function well known to those skilled in the art. Detailed description thereof is therefore omitted. The route guide 111 can set, as a destination, a charging facility that offers incentive information and that has been outputted from the charging facility suggestion device 30, and perform route guidance to the set charging facility.

The suggestion request transmitter 112 transmits, through wireless communication using the communicator 13, suggestion request information including the position information of the vehicle 50 and a charging facility suggestion request to the charging facility suggestion device 30.

The incentive information presentation unit 113 can receive facility information pertaining to a charging facility(ies) located within a predetermined range from the current position of the vehicle 50 and incentive information from the charging facility suggestion device 30, and provide the information to the user by, for example, outputting the information to the display unit 15. For example, the information is outputted to the display unit 15 in the form of a list or in the form of representations such as icons displayed on a display map. These output forms allow the user to select a desired charging facility by, for example, tapping on the position indicating the charging facility on the display unit 15 (that includes a touch panel) or by tapping on the charging facility from the list. It should be noted that the output of the information is not limited to these forms. The user can set any output form. Specifically, for example, the incentive information presentation unit 113 can display, on the display unit 15, the position of a charging facility(ies) with the incentive information added thereto on a map of an area including the current position of the vehicle 50 based on the facility information and the incentive information received from the charging facility suggestion device 30. In a case where there are multiple charging facilities to which incentive information has been added in the vicinity of the vehicle 50, the incentive information presentation unit 113 may display the charging facility information containing the multiple charging facilities on the display unit 15 in a scrollable manner. The incentive information presentation unit 113 may also separately present charging facilities that do not offer incentive information in addition to the charging facility(ies) to which the incentive information has been added.

Upon the user selecting a charging location based on the facility information and the incentive information received from the charging facility suggestion device 30, the charging facility reservation transmitter 114 can transmit, to the charging facility suggestion device 30, identification information of the charging facility selected by the user (including a charging apparatus ID if the charging facility has a plurality of charging apparatuses) and identification information of the incentive information (if the user selects one of a plurality of pieces of incentive information). At the same time, the charging facility reservation transmitter 114 may also transmit a charging start time and a charging duration if such information is specified by the user. The configuration of the in-vehicle navigation device 10 has been described above.

### Functional Blocks of Portable Terminal 20

Next, functional blocks of the portable terminal 20 will be described with reference to the block diagram in FIG. 3. As shown in FIG. 3, the portable terminal 20 includes a controller 21, a storage 22, a communicator 23, a sensor 24, a display unit 25, and an input unit 26. The controller 21, the storage 22, the communicator 23, the sensor 24, the display unit 25, and the input unit 26 have functions equivalent to those of the functional blocks having the same names included in the in-vehicle navigation device 10 described above. That is, the description of the in-vehicle navigation device 10 given above can be used as the description of the functional blocks of the portable terminal 20 by replacing the phrase “in-vehicle navigation device 10” with “portable terminal 20”, and thus the same descriptions will not be repeated. It is preferable that the user's portable terminal 20 be pre-registered in the charging facility suggestion device 30 in association with the identification information of the vehicle that is used by the user. Specifically, for example, it is preferable that a login ID for logging into the charging facility suggestion device 30 be associated with the identification information of the vehicle 50. In this case, the charging facility suggestion device can recognize both the user's portable terminal 20 and the vehicle 50 as the “vehicle side”. The configuration of the portable terminal 20 has been described above.

### Functional Blocks of Charging Facility Suggestion Device 30

Next, functional blocks of the charging facility suggestion device 30 will be described with reference to the block diagram in FIG. 4.

As shown in FIG. 4, the charging facility suggestion device 30 includes a controller 31, a storage 32, a communicator 33, a display unit 34, and an input unit 35.

The controller 31 includes an arithmetic processor such as a microprocessor and controls components of the charging facility suggestion device 30. Details of the controller 31 are described below.

The storage 32 includes, for example, semiconductor memory. The storage 32 stores a control program, which is referred to as firmware or an operating system, programs for executing charging facility suggestion processing, and various other information such as map information. As such, as shown in FIG. 4, the storage 32 has storage units reserved therein such as a map information storage 321 and a vehicle information storage 322. It should be noted that these storage units may be reserved separately or integrated as a single unit in the storage 32.

Charging facility information pertaining to charging facilities for charging vehicles is stored in the map information storage 321. The charging facility information of each charging facility includes, for example, identification information of the charging facility (facility ID), a name of the facility, a facility type (category type), a telephone number, an address, operating hours, position information identified using coordinates including latitude and longitude, output performance (charging speed) of a charger(s) (charging apparatus) provided at the charging facility, and incentive information preset for the charger (charging apparatus) and associated with the output performance (charging speed) of the charger (charging apparatus) and the battery capacity of vehicles. In the case of a charging facility having a plurality of chargers (charging apparatuses), the charging facility information includes, for each charger (charging apparatus), identification information (charger ID) for identifying the charger (charging apparatus) and performance of the charger. In the present embodiment, the incentive information can be set for each charging facility as appropriate. In this configuration, different incentive information can be set for each charging facility for various reasons specific to each charging facility even if the chargers (charging apparatuses) at different charging facilities have the same performance.

As a modification example, the same incentive information may be set for different charging facilities as long as the output performance (charging speed) of the chargers (charging apparatuses) is the same. In this case, instead of including charging facility-specific incentive information in the charging facility information, for example, an incentive information table (not shown) created by associating incentive information with the output performance (charging speed) of chargers (charging apparatuses) and the battery capacity of vehicles may be stored in the storage 32, so that an incentive information creation unit 313 described below creates incentive information for a desired vehicle by referring to the incentive information table (not shown). In this case, the incentive information table (not shown) may be an internal table in the incentive information creation unit 313 described below. The following briefly describes the charging facilities and the chargers (charging apparatuses) before describing the charging facility information.

The charging facilities are, for example, external charging facilities, excluding residential charging facilities (charging at private locations such as home) according to classification based on the installation location of chargers (charging apparatuses). Examples of external charging facilities include: public facilities along major roads to stop at during long-distance travel such as SAs and PAs on highways, and roadside visitor centers; car dealers where electric vehicles are sold; facilities frequently visited on a routine basis such as convenience stores, supermarkets, shopping malls, and restaurants; lodging facilities such as hotels where vehicles are parked for long periods of time; and toll parking lots where vehicles are temporarily parked. The facility ID is unique identification information assigned to each facility. The facility ID is preferably assigned on a per-facility type basis. Examples of facility types include the commercial establishment types of the charging facilities listed above. Note here that the identification information of each charging facility as a general facility may be used as the identification information (facility ID) of the charging facility. Each facility ID has position information (map information) specified by, for example, coordinates including latitude and longitude where the corresponding facility is located. The map information may include display map data for displaying backgrounds such as roads, road maps, and the like, position information and type information of nodes (for example, intersections, curve points, end points, and the like of roads), position information and type information of links, which are routes connecting nodes, road network data including link cost data pertaining to cost information (for example, distance and time required) of all the links, and other information and data.

The charging facilities each have a charger (also referred to as a “charging apparatus”) available to users. Some charging facilities have a plurality of chargers (charging apparatuses). Some charging facilities have different types of chargers (charging apparatuses) (for example, a standard charger and a fast charger described below). It is therefore desirable that each charger (charging apparatus) provided at the charging facilities be assigned a charger ID (charging apparatus ID), which is unique identification information. For each charger ID (charging apparatus ID), the output performance (charging speed) of the charger (charging apparatus) and the incentive information for when the vehicle 50 uses the charger (charging apparatus) for charging are preset and associated. Next, the output performance (charging speed) and incentive information of each charger included in the charging facility information will be described in detail.

First, the output performance (charging speed) of the charger (charging apparatus) will be described. Chargers (charging apparatuses) are broadly classified into standard chargers and fast chargers. Standard charging refers to, for example, charging with an output performance of 3 kW using an alternating-current power source (200 V/15 A or 100 V/30 A). It should be noted that standard chargers include not only 3 kW chargers but also high-power standard chargers having an output of as high as 6 kW. In contrast, fast charging refers to charging with an output of, for example, 20 kW or higher using a direct-current power source. However, fast chargers can have various output performances, and thus may be, for example, classified into the following categories: medium-speed chargers having an output performance of 20 kW to 30 kW, fast-speed chargers having an output performance of 30 kW to 50 kW, ultrafast-speed chargers having an output performance of 70 kW, and super-fast-speed chargers having an output performance of 90 KW or higher. The categories and types mentioned above are merely examples, and fast chargers are classified into a plurality of levels by those skilled in the art. The charging facility information includes output performance information (charging speed information) set for each charging apparatus provided at the charging facility in association with the charger ID (charging apparatus ID) of the charging apparatus. As mentioned above, in terms of the output performance (charging speed), chargers (charging apparatuses) can be classified, for example, into the following categories: standard chargers capable of 3 kWh or 6 kWh charging, medium-speed chargers having an output performance of 20 kW to 30 kW, fast-speed chargers having an output performance of 40 kW to 50 kW, ultrafast-speed chargers having an output performance of 70 kW, and super-fast-speed chargers having an output performance of 90 kW or higher. Each charging facility is equipped with a charger selected based on users' behavior at the charging facility. Typically, convenience stores, roadside visitor centers, home centers, and the like, which may be referred to as en-route charging facilities, are equipped with medium-speed chargers, and public facilities along major roads for long-distance travel, such as SAs and PAs on highways, are equipped with fast-speed chargers. In addition, facilities such as hotels, which may be referred to as destination charging facilities, have a high tendency to be equipped with standard chargers.

The following describes the incentive information of the chargers (charging apparatuses). Each charger (charging apparatus) provided at the charging facilities has incentive information preset according to the capacity of a battery (also referred to as “battery capacity” or “electric power amount”) of each electric vehicle chargeable using the charger (charging apparatus), to be given to (the user of) the electric vehicle.

As mentioned above, for example, electric vehicles put on the market around 2010 include vehicles having a battery capacity of approximately 20 kWh. Among electric vehicles recently put on the market around 2020, small-capacity electric vehicles having a battery capacity of 30 kWh to 40 kWh, medium-capacity electric vehicles having a battery capacity of 50 kWh to 60 kWh, and large-capacity electric vehicles having a battery capacity of 70 kWh to 90 kWh or more may be mentioned as examples of electric vehicles in terms of the battery capacity of electric vehicles. For convenience, vehicles having a battery capacity of approximately 20 kWh are classified as small-capacity vehicles. The classification of electric vehicles in terms of the battery capacity described above is merely an example, and may be determined as appropriate by an administrator of the charging facility suggestion system.

As mentioned above, in terms of the output performance (charging speed) of chargers (charging apparatuses), chargers are classified into, for example, standard chargers capable of 3 kWh or 6 kWh charging, medium-speed chargers having an output performance of 20 kW to 30 kW, fast-speed chargers having an output performance of 40 kW to 50 kW, ultrafast-speed chargers having an output performance of 70 kW, and super-fast-speed chargers having an output performance of 90 kW or higher. Then, for example, a standard charger (charging apparatus) takes 12 hours (in the case of 3 kWh) or 6 hours (in the case of 6 kWh) to complete 90% charge for a small-capacity electric vehicle having a battery capacity of 40 kWh. Accordingly, in view of the object of promoting the spread of electric vehicles that are designed with consideration for environmental burden on society as a whole, that target users who mainly drive within the city, and that have smaller battery capacities, as well as the spread of charging facilities suitable for such electric vehicles, the most beneficial incentive information may be given to the user of a small-capacity electric vehicle for charging the small-capacity electric vehicle, in the case of a charger (charging apparatus) having a standard output performance (charging speed).

Conversely, in the case of a fast charger (charging apparatus) having 20 kW or higher using a direct-current power source, it is not preferable to give more beneficial incentive information to a small-capacity electric vehicle compared to medium and large-capacity electric vehicles, for example, even if the small-capacity electric vehicle includes a battery having lower performance than the output performance of the fast charger is not preferable. This is because such incentive information can be interpreted as encouraging vehicles not suitable for high performance to occupy fast chargers. Thus, setting the incentive information as described above makes it possible to lead small-capacity electric vehicles to perform charging using lower performance chargers (charging apparatuses) having a predetermined output performance or lower including standard chargers, promoting the spread of electric vehicles that are designed with consideration for environmental burden on society as a whole and that have smaller battery capacities, as well as the spread of lower performance chargers (charging apparatuses) including standard chargers. It should be noted that small-capacity electric vehicles, for example, may be further classified by categorizing their small battery capacities into a plurality of levels, and the incentive information may be set so as to be more beneficial or so as not to be less beneficial for a vehicle having a battery capacity categorized as a lower level.

The following describes the incentive information in the case of charging of medium-capacity and large-capacity electric vehicles. If a medium-capacity or a large-capacity electric vehicle is charged using a standard charger, the standard charger is expected to be occupied for a long time. That is, it is not preferable to give incentive information to the user of a medium-capacity or large-capacity electric vehicle for using a standard charger, because such incentive information can be interpreted as encouraging medium-capacity or large-capacity vehicles to use standard chargers. In the case of charging of medium-capacity and large-capacity electric vehicles, it is considered normal to select fast charging or higher output fast charging as the output performance (charging speed) of the charger (charging apparatus). It is therefore considered not particularly necessary to give incentive information to users of medium-capacity and large-capacity electric vehicles for selecting fast charging or higher output fast charging. Furthermore, given that the aim of the present invention is to promote the spread of electric vehicles that are designed with consideration for environmental burden on society as a whole and that have smaller battery capacities as well as the spread of standard chargers, it is considered not particularly necessary to give incentive information to users of medium-capacity and large-capacity electric vehicles. In the case of a charging facility having both a fast charging apparatus and a higher output fast charging apparatus, it is expected that there is a motivation to lead users of medium-capacity electric vehicles to use the fast charging apparatus and to encourage users of large-capacity electric vehicles to use the higher output fast charging apparatus. Accordingly, the incentive information may be set to be given to the user of a medium-capacity electric vehicle for using, for example, a fast charging apparatus and to be given to the user of a large-capacity electric vehicle for using, for example, a fast-speed charger having an output performance of 40 kW to 50 kW or an ultrafast-speed charger having an output performance of 70 kW.

Specific examples of incentive information that may be offered include a priority reservation for the charger (charging apparatus) and/or a discount on the unit charging price. To summarize the foregoing, the following configuration is preferable with respect to the incentive information, which is preset for each charger (charging apparatus) provided at the charging facilities.

The incentive information included in the charging facility information pertaining to each charging facility is preset for each charger (charging apparatus) provided at the charging facility. Specifically, for example, in the case of a charger (charging apparatus) having an output performance (charging speed) lower than or equal to a predetermined output performance (charging speed), the incentive information may be given to an electric vehicle having a battery capacity smaller than or equal to a predetermined battery capacity (for example, a small capacity). For example, a priority reservation for the charger (charging apparatus) and/or a discount on the unit charging price may be set as the incentive information. Electric vehicles having a battery capacity smaller than or equal to a predetermined battery capacity (for example, a small capacity) may be further classified by categorizing their battery capacities into a plurality of levels, and the incentive information may be set so as to be more beneficial for a vehicle having a battery capacity categorized as a lower level. The predetermined battery capacity is not limited to a battery capacity included in small capacities. The predetermined battery capacity may be, for example, a battery capacity included in medium capacities. In the case of a charging facility having a fast charger (charging apparatus) or a higher output fast charger, the charging facility suggestion device 30 may refrain from setting the incentive information for the charger. However, in the case of a charging facility having a fast charging apparatus and a higher output fast charging apparatus, the incentive information may be set to be given to the user of a medium-capacity electric vehicle for using, for example, a medium-speed charger and to be given to the user of a large-capacity electric vehicle for using the higher output fast charging apparatus.

The incentive information that is offered to (users of) electric vehicles has been described above as being set for each charging facility based on the battery capacity of the electric vehicles and the output performance (charging speed) of chargers (charging apparatuses) to be used for charging the electric vehicles. However, the incentive information is not limited as such. As mentioned above, the incentive information may be set so as to encourage medium-capacity electric vehicles and large-capacity electric vehicles to use a fast charger or a higher output fast charger. As has been described above, the incentive information may be created so as to benefit a vehicle having a smaller battery capacity over vehicles having larger battery capacities. As a modification example, as mentioned above, the same incentive information may be set for different charging facilities as long as the output performance (charging speed) of the chargers (charging apparatus) is the same. The map information storage 321 has been described above, which stores the charging facility information pertaining to the charging facilities for charging vehicles.

The following describes the vehicle information storage 322. In the vehicle information storage 322 of the storage 32, vehicle identification information (vehicle identification ID) of electric vehicles of the users registered in the charging facility suggestion device 30, vehicle name information and/or vehicle model information associated with the vehicle identification information (vehicle identification ID), and battery capacity information of the vehicles are stored and associated with each other. With such information, the vehicle side (for example, a vehicle or a terminal of the user of the vehicle) can log into the charging facility suggestion device 30 using, for example, the vehicle identification information (vehicle identification ID). Furthermore, upon the vehicle side (for example, a vehicle or a terminal of the user of the vehicle) sending suggestion request information including the position information of the vehicle and a charging facility suggestion request, a suggestion request input unit 311 described below can acquire the vehicle name information and/or the vehicle model information associated with the vehicle identification information (vehicle identification ID) of the vehicle and the battery capacity information of the vehicle, and provide the identification information, the position information, and the battery capacity information of the vehicle 50 to a charging facility search unit 312 and the incentive information creation unit 313. It should be noted that the vehicle identification information (vehicle identification ID) of electric vehicles and the vehicle name information and/or the vehicle model information associated with the vehicle identification information (vehicle identification ID) may be stored in the vehicle information storage 322, and a vehicle model information-battery capacity table (not shown), in which the vehicle name information and/or the vehicle model information and the battery capacity information are associated with each other, may be stored in the storage 32, so that the suggestion request input unit 311 described below can acquire the battery capacity of a desired vehicle by referring to the vehicle model information-battery capacity table (not shown). In this case, the vehicle model information-battery capacity table (not shown) may be an internal table of the suggestion request input unit 311 described below.

The communicator 33 has, for example, a DSP and implements communication with other devices via the communication network 60 in accordance with a standard such as Long Term Evolution (LTE), 4th Generation (4G), 5th Generation (5G), or Wi-Fi (registered trademark). For example, the communicator 33 implements wireless or wired communication between the charging facility suggestion device 30 and the vehicle side, and wireless or wired communication between the charging facility suggestion device 30 and the charging facility information processing device 40. The communicator 33 is, for example, used to receive data such as a connection request from the vehicle side, the position information of the vehicle, and the suggestion request information, or conversely to transmit the charging facility information and the incentive information to the vehicle side. Furthermore, the communicator 33 is, for example, used to transmit information pertaining to the vehicle intending to use the charging facility and the incentive information to the charging facility information processing device 40, and conversely to receive the usage status of the charging apparatus and charging completion information from the charging facility information processing device 40. However, no particular limitations are placed on data transmitted and received between the communicator 33 and other devices, and information other than those mentioned above may be transmitted and received.

Next, the details of the controller 31 will be described. The controller 31 includes a microprocessor having, for example, a central processing unit (CPU), random access memory (RAM), read only memory (ROM), and input/output (I/O) capabilities. The CPU executes each program read from the ROM or the storage 32 by reading information from the RAM, the ROM, and the storage 32 during the execution, writes information to the RAM and the storage 32, and exchanges signals with the communicator 33, the display unit 34, and the input unit 35. In this way, hardware and software (program) cooperate with each other to implement processing in the present embodiment. As such, by executing each program, the controller 31 causes the charging facility suggestion device 30, which is a computer, to implement predetermined functions (collectively referred to below as “charging facility suggestion control blocks”). Furthermore, by executing each program, the controller 31 causes the charging facility suggestion device 30 to execute predetermined steps (collectively referred to below as “charging facility suggestion steps”). The following describes functions of the controller 31 in terms of the charging facility suggestion control blocks. It should be noted that description in terms of the charging facility suggestion control steps (method) is omitted, because such description can be obtained by interpreting “units” as “steps” below.

The controller 31 includes, as functional blocks, a charging facility interface 310, the suggestion request input unit 311, the charging facility search unit 312, the incentive information creation unit 313, an incentive information output unit 314, and a charging facility reservation input unit 315.

### Charging Facility Interface 310

The charging facility interface 310, for example, periodically acquires the usage status of the chargers (charging apparatuses) provided at the charging facilities from the charging facility information processing devices 40 that manage the chargers (charging apparatuses) at the charging facilities, and stores the acquired usage status in the storage 32. Examples of the usage status of the chargers (charging apparatuses) include “in use” (charging), “available”, “reserved”, and “not reserved”. Thus, for each vehicle that has transmitted a suggestion information request, the incentive information output unit 314 described below can output, to the vehicle side, incentive information together with the usage status of chargers (charging apparatuses) provided at charging facilities located within a predetermined range from the position of the vehicle. Upon the vehicle side selecting, as a charging location, a charging apparatus that offers the incentive information and that has been outputted from the incentive information output unit 314 described below, the charging facility interface 310 may transmit charging facility suggestion information to the corresponding charging facility information processing device 40 together with the vehicle information. Thus, the charging facility can plan the use of the charger (charging apparatus) based on the incentive information. Upon the vehicle that is using the incentive information completing charging using the charging apparatus, the charging facility interface 310 can obtain, from the charging facility information processing device 40, a notification indicating that the vehicle has completed charging using the charging apparatus. In this case, the charging facility interface 310 may give the charging facility information processing device 40 a notification containing reward information for a reward for referring a customer.

### Suggestion Request Input unit 311

The suggestion request input unit 311 receives, from the vehicle side via the communicator 33, the identification information and the position information of the vehicle 50, and a suggestion information request for requesting suggestion of a charging facility. Note here that the identification information of the vehicle 50 is associated with the vehicle name information and/or the vehicle model information of the vehicle. The suggestion request input unit 311 can acquire the battery capacity information of the vehicle based on the vehicle name information and/or the vehicle model information of the vehicle by referring to the vehicle information storage 322. The suggestion request input unit 311 may receive the identification information and the position information of the vehicle 50, and the battery capacity information of the vehicle from the vehicle side, and provide the received information to the charging facility search unit 312 and the incentive information creation unit 313.

### Charging Facility Search unit 312

The following describes the charging facility search unit 312. For each of vehicles that have transmitted a suggestion information request, the charging facility search unit 312 can search for charging facilities located within a predetermined range from the position of the vehicle 50 by referring to the charging facility information stored in the map information storage 321 based on the position information of the vehicle. The predetermined range herein may be a range based on the distance from the position of the vehicle or may be an administrative area that includes the position of the vehicle. Alternatively or additionally, the predetermined range may be specified by the vehicle side. Thereafter, the charging facility search unit 312 temporarily stores a set of charging facility information found for each vehicle from which the suggestion information request has been received, in the storage 32 on a vehicle-by-vehicle basis and gives a notification to the incentive information creation unit 313. In response, the incentive information creation unit 313 described below can create, for each vehicle from which the suggestion information request has been received, incentive information to be offered by each charging facility contained in the set of charging facility information to the vehicle, based on the battery capacity information of the vehicle and the set of charging facility information containing the charging facilities located within the predetermined range from the position of the vehicle.

### Incentive Information Creation unit 313

The incentive information creation unit 313 creates, based on the charging facility information containing the charging facilities found for each vehicle, incentive information so as to benefit a vehicle having a smaller battery capacity more according to the battery capacity indicated by the battery capacity information of each vehicle. Specifically, the incentive information creation unit 313 refers to the map information storage 321 to acquire the output performance (charging speed) and incentive information of the charger (charging apparatus) at each charging facility contained in the set of charging facility information. The incentive information creation unit 313 acquires incentive information corresponding to the battery capacity of the vehicle and the output performance (charging speed) of the charger (charging apparatus) at each charging facility. In the present embodiment, the incentive information can be provided so as to benefit a vehicle having a smaller battery capacity over vehicles having larger battery capacities. For example, in the case of a charger (charging apparatus) having an output performance (charging speed) lower than or equal to a predetermined output performance (charging speed), incentive information thereof can be offered to a vehicle having a small battery capacity. Thus, the vehicle side (incentive information presentation unit 113 or 213) that has received the incentive information can select a charging facility having a charging apparatus that can offer the incentive information from among the charging facilities located within the predetermined range from the position of the vehicle, and the vehicle side (charging facility reservation transmitter 114 or 214) can reserve the charging apparatus provided at the charging facility. The processing in the incentive information creation unit 313 of the present embodiment has been described based on the incentive information mentioned as an example in the description of the map information storage 321. However, the processing is not limited to what has been described above. As mentioned above, in the case of charging facilities each having a fast charging apparatus and a higher output fast charging apparatus, a vehicle having a medium battery capacity or a large battery capacity can select a charging facility having a fast charging apparatus and a higher output fast charging apparatus that can offer incentive information set according to the output performance (charging speed) of the chargers to the vehicle from among charging facilities that are located within the predetermined range from the position of the vehicle. Furthermore, the incentive information of the present embodiment has been described as being settable for each charging facility as appropriate. However, as mentioned above as a modification example, the same incentive information may be set for different charging facilities as long as the output performance (charging speed) of the chargers (charging apparatuses) is the same. In this case, an incentive information table (not shown) created by associating incentive information with the output performance (charging speed) of each charger (charging apparatus) and the battery capacity of each vehicle is stored in the storage 32, so that the incentive information creation unit 313 can create incentive information for a desired vehicle by referring to the incentive information table (not shown).

### Incentive Information Output unit 314

The incentive information output unit 314 can provide the vehicle side with incentive information together with the usage status of each charging facility located within the predetermined range from the position of the vehicle and contained in the set of charging facility information.

Specifically, for example, the incentive information output unit 314 may output the position of each charging facility that offers incentive information in the form of an icon or a display tile together with the content of the incentive information. The incentive information output unit 314 may refrain from outputting charging facilities that do not offer incentive information. Thus, the user of the vehicle can use, for example, a charging facility that offers incentive information. The incentive information output unit 314 may be enabled to output the information in the form of a list. When failing to output any charging facility that offers incentive information, the charging facility suggestion device 30 may provide an output for selection of whether or not to expand the search range for charging facilities.

### Charging Facility Reservation Input unit 315

Upon the user selecting, from the vehicle side, a charging facility that offers incentive information, the charging facility reservation input unit 315 provides the charging facility interface 310 with the charging facility information pertaining to the selected charging facility together with the vehicle information of the user. At the same time, the charging facility reservation input unit 315 also provides the charging facility interface 310 with a charging start time and a charging duration if such information is specified by the user. Thus, as described above, the charging facility interface 310 can transmit charging facility suggestion information to the charging facility information processing device 40 together with the vehicle information. The configuration of the charging facility suggestion device 30 has been described above.

Finally, the charging facility information processing device 40 will be described. As described above, the charging facility information processing device 40 is, for example, provided for each charging facility, and manages the usage status of each charging apparatus provided at the charging facility. As shown in FIG. 5, the charging facility information processing device 40 includes a controller 41, a storage 42, a communicator 43, a display unit 44, and an input unit 45.

The controller 41 includes an arithmetic processor such as a microprocessor and controls components of the charging facility information processing device 40. Details of the controller 41 are described below.

The usage status (for example, in use (charging a vehicle), completed charging, available, reserved, not reserved) of each charger (charging apparatus) provided at the charging facility being managed is stored in the storage 42 together with user information and date/time information. Among the charging apparatuses provided at the charging facility being managed, a charging apparatus(es) that has incentive information is stored in association with the incentive information. In a case where the user using a charger (charging apparatus) is a user referred by the charging facility suggestion device 30, information indicating that the user has been referred by the charging facility suggestion device 30 is stored as part of the usage status of the charger (charging apparatus). Furthermore, in a case where the user using a charger (charging apparatus) is a user referred by the charging facility suggestion device 30, billing information (for a reward for referring a customer) transmitted from the charging facility suggestion device 30 is stored.

The communicator 43 is, for example, used to receive information pertaining to the vehicle intending to use the charging facility and incentive information thereof from the charging facility suggestion device 30, and conversely to transmit the usage status of the charger (charging apparatus) and charging completion information to the charging facility suggestion device 30.

The controller 41 includes, as functional blocks, a charging apparatus interface 410 and a suggestion device interface 411.

The charging apparatus interface 410 periodically acquires, from each charger (charging apparatus) provided at the charging facility being managed, the usage status of the charger (charging apparatus) and stores the acquired usage status in the storage 42.

The suggestion device interface 411 reports the usage status of each charger (charging apparatus) to the charging facility suggestion device 30 periodically or upon request. Upon the vehicle side selecting, as a charging location, a charging apparatus provided at the charging facility that offers incentive information and that has been outputted from the charging facility suggestion device 30, the charging apparatus interface 410 receives information pertaining to the vehicle intending to use the charging facility from the charging facility suggestion device 30. Accordingly, the suggestion device interface 411 places the charging apparatus at the charging facility into the reserved state. The suggestion device interface 411 may also receive reward information for a reward for referring a customer from the charging facility suggestion device 30. Conversely, the suggestion device interface 411 notifies the charging facility suggestion device 30 that the vehicle 50 has completed charging using the charging apparatus when the vehicle 50 has completed charging using the charging apparatus at the charging facility suggested by the charging facility suggestion device 30. The configuration of the charging facility information processing device 40 has been described above.

The functional blocks in the charging facility suggestion system 1 according to an embodiment of the present invention have been described based on the configurations of the vehicle-side device, the portable terminal 20, the charging facility suggestion device 30, the charging facility information processing devices 40, and the charging facilities. It should be noted that the functional blocks of the charging facility suggestion device 30 according to the foregoing embodiment of the present invention may be developed to be implemented on a single computer, or distributed and implemented across a plurality of computers that are located in the same place or distributed across different places and connected to one another via a communication network. Furthermore, the functional blocks of the charging facility suggestion device 30 according to the foregoing embodiment of the present invention may be configured using a plurality of virtual computers on a cloud.

### Operation of Present Embodiment

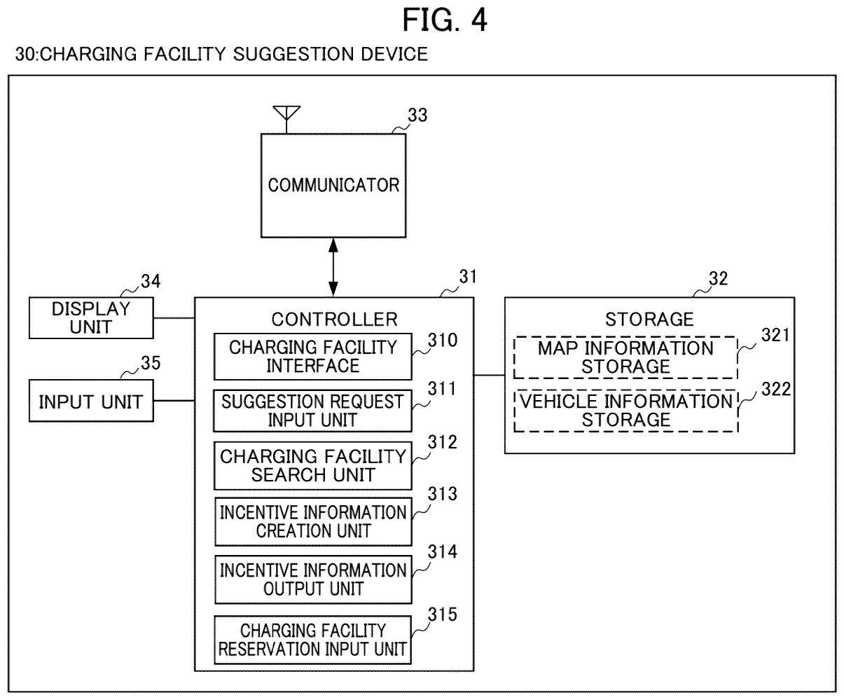

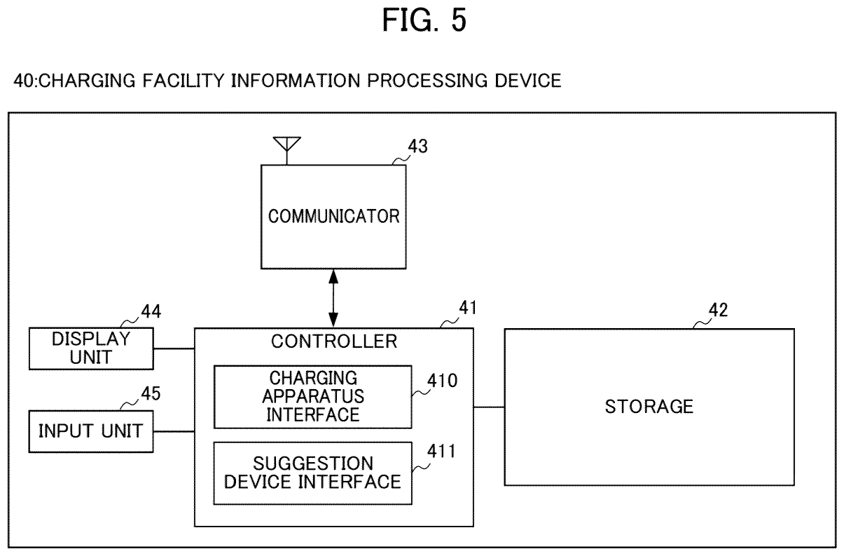

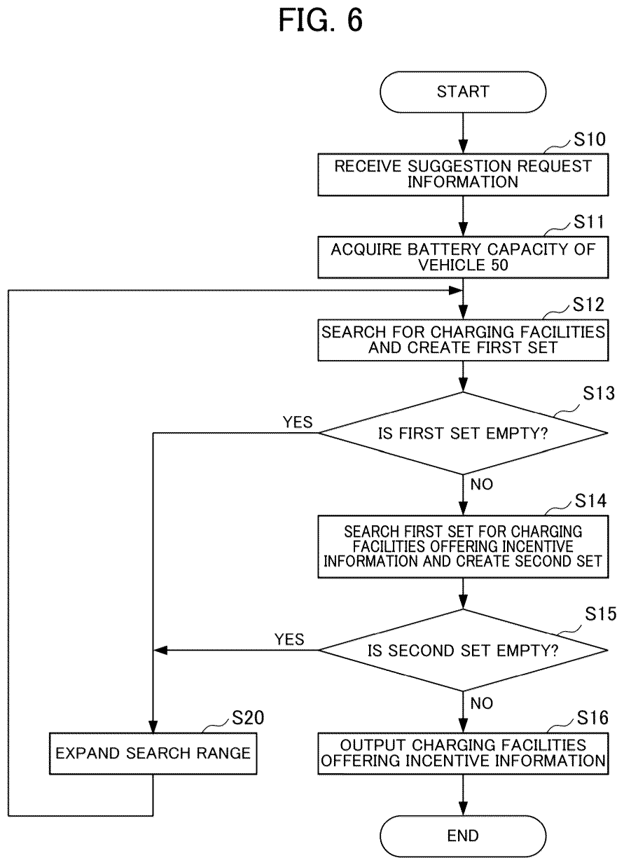

The following describes operation of the charging facility suggestion device 30 according to the present embodiment during the charging facility suggestion processing with reference to a flowchart in FIG. 6. FIG. 6 is a flowchart showing the operation during the charging facility suggestion processing to be performed when the charging facility suggestion device 30 receives a suggestion information request from the vehicle side, and then provides the vehicle side with charging facility information containing charging facilities having charging apparatuses that can offer incentive information. The processing flow shown in FIG. 6 is on the assumption that the vehicle identification information (vehicle identification ID) and the vehicle name information and/or the vehicle model information of the vehicle 50, and the charging facility information including the incentive information have been already registered in the charging facility suggestion device 30. Furthermore, although not shown, the processing flow shown in FIG. 6 is on the assumption that the charging facility suggestion device 30 periodically acquires the usage status of each charging apparatus from the charging facility information processing devices 40 in the background. In the following processing flow, the charging facility suggestion device 30 expands the predetermined range and searches for charging facilities again when failing to find any charging facility that offers incentive information within the predetermined range from the position of the vehicle. However, the processing is not limited as such. When failing to find any charging facility that offers incentive information within the predetermined range from the position of the vehicle, although not shown, the charging facility suggestion device 30 may stop searching and notifies the vehicle side that no charging facility offering incentive information has been found.

Referring to the flowchart in FIG. 6, in Step S10, the charging facility suggestion device 30 (suggestion request input unit 311) is logged in from the vehicle side and receives suggestion request information including the position information of the vehicle and a charging facility suggestion request.

In Step S11, the charging facility suggestion device 30 (suggestion request input unit 311) acquires the battery capacity of the vehicle 50 that has transmitted the suggestion request information by referring to the vehicle model information-battery capacity table (not shown).

In Step S12, the charging facility suggestion device 30 (charging facility search unit 312) searches for charging facilities located within the predetermined range from the position of the vehicle 50 and temporarily stores, in the storage 32, a set of charging facility information (referred to below also as a “first set”) containing charging facilities located within the predetermined range.

Upon determining that the first set is empty in Step S13, the charging facility suggestion device 30 (charging facility search unit 312) advances to Step S20. Upon determining that the first set is not empty, the charging facility suggestion device 30 advances to Step S14.

In Step S14, the charging facility suggestion device 30 (incentive information creation unit 313) acquires a set of charging facility information (referred to below as a “second set”) containing charging facilities having charging apparatuses that offer incentive information corresponding to the battery capacity of the vehicle 50 among the charging facilities contained in the first set, and temporarily stores the second set in the storage 32.

Upon determining that the second set is empty in Step S15, the charging facility suggestion device 30 (incentive information creation unit 313) advances to Step S20. Upon determining that the second set is not empty, the charging facility suggestion device 30 (incentive information creation unit 313) advances to Step S16.

In Step S16, the charging facility suggestion device 30 (incentive information output unit 314) outputs, to the vehicle side (incentive information presentation unit 113 or 213), the charging facility information acquired based on the second set containing charging facilities having charging apparatuses that offer incentive information, with the usage status of each charging facility added thereto. The charging facility suggestion device 30 then ends the processing.

In Step S20, the charging facility suggestion device 30 (charging facility search unit 312) expands the search range.

The charging facility suggestion device 30 then returns to Step S12.

Through the processing flow described above, the charging facility suggestion device 30 can receive a suggestion information request from the vehicle side, and then provide the vehicle side with charging facility information containing charging facilities having charging apparatuses that can offer incentive information. Furthermore, the vehicle side can display the information on, for example, the display unit 15 or the display unit 25 through the incentive information presentation unit 113 or the incentive information presentation unit 213, and can also make a reservation, for example, by selecting a charging apparatus provided at any of the charging facilities.

### Hardware and Software

Each of the devices included in the charging facility suggestion system described above can be implemented by hardware, software, or a combination thereof. A method for inputting and outputting charging facility suggestion including incentive information that is carried out through cooperation of the devices included in the charging facility suggestion system described above can be also implemented by hardware, software, or a combination thereof. Being implemented by software herein means being implemented through at least one computer reading and executing at least one program.

The program can be supplied to the computer by being stored on any of various types of non-transitory computer readable media. The non-transitory computer readable media include various types of tangible storage media. Examples of non-transitory computer readable media include magnetic storage media (such as flexible disks, magnetic tape, and hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM), erasable PROM (EPROM), flash ROM, and random access memory (RAM)). Alternatively, the program may be supplied to the computer using any of various types of transitory computer readable media. Examples of transitory computer readable media include electrical signals, optical signals, and electromagnetic waves. Transitory computer readable media are able to supply the program to the computer through a wireless communication channel or a wired communication channel such as electrical wires or optical fibers.

### Modification Examples

The embodiment described above is a preferred embodiment of the present invention. However, the scope of the present invention is not limited solely to the embodiment described above. The embodiment may be modified in a variety of ways to practice the present invention without departing from the gist of the present invention.

### Modification Example 1

The functional configurations of the foregoing embodiment may be modified. That is, the functional configurations shown in FIGS. 2, 3, 4, and 5 are merely examples, and do not limit the functional configurations of the foregoing embodiment. In other words, functional blocks to be used to implement the charging facility suggestion functionality according to the present invention are not particularly limited to the examples shown in FIGS. 2, 3, 4, and 5, as long as the devices have functions that make it possible to implement the series of processes related to this functionality as a whole.

The description of the devices for implementing functional configurations given above for the foregoing embodiment is also merely an example. For example, the charging facility suggestion device 30 according to the foregoing embodiment is described as being implemented by, for example, a single server device, but may alternatively be implemented by a distributed processing system in which the functions of the charging facility suggestion device 30 are distributed across a plurality of server devices as appropriate. Alternatively, each of the functions of the charging facility suggestion device 30 may be implemented using, for example, a virtual server function on a cloud.

Furthermore, the display unit 34 and the input unit 35 described as being included in the charging facility suggestion device 30 may alternatively be implemented in a separate device from the device that implements the other components of the charging facility suggestion device 30. For example, the controller 31, the storage 32, and the communicator 33 may be implemented in a device, and the display unit 34 and the input unit 35 may be implemented in a separate device. In this configuration, these two devices may communicate with each other via the communication network 60.

### Modification Example 2

As mentioned above, the foregoing embodiment may have a configuration in which the charging facility information pertaining to each charging facility stored in the storage 32 of the charging facility suggestion device 30 can be created and updated as appropriate according to, for example, input from an administrator of the charging facility through, for example, a charging facility terminal device (not shown) provided at the charging facility. For example, the foregoing embodiment may have a configuration in which the administrator logs into the charging facility suggestion device 30 through the charging facility terminal device. Then, after determining that the administrator's user ID is valid, the charging facility suggestion device 30 transmits an edit processing screen for creating and updating the charging facility information to the charging facility terminal device, so that the charging facility information can be edited through the charging facility terminal device. This configuration allows the charging facility information to be created and updated as appropriate according to, for example, input from the administrator of the charging facility.

### EXPLANATION OF REFERENCE NUMERALS

1: Charging facility suggestion system
10: In-vehicle navigation device
20: Portable terminal
11, 21: Controller
111, 211: Route guide
112, 212: Suggestion request transmitter
113, 213: Incentive information presentation unit
114, 214: Charging facility reservation transmitter
12, 22: Storage
121, 221: Map information
122, 222: Position information
123, 223: Identification information
13, 23: Communicator
14, 24: Sensor
15, 25: Display unit
16, 26: Input unit
30: Charging facility suggestion device
31: Controller
310: Charging facility interface
311: Suggestion request input unit
312: Charging facility search unit
313: Incentive information creation unit
314: Incentive information output unit
315: Charging facility reservation input unit
32: Storage
321: Map information storage
322: Vehicle information storage
40: Charging facility information processing device
50: Vehicle (electrically powered vehicle, electric vehicle)
60: Communication network (network)

1. A charging facility suggestion device comprising:
a map information storage configured to store charging facility information pertaining to charging facilities for charging vehicles;
a vehicle information storage configured to store identification information and battery capacity information of a plurality of vehicles;
a suggestion request input unit configured to receive, from a vehicle included in the plurality of vehicles or a terminal of a user of the vehicle, suggestion request information including position information of the vehicle and a charging facility suggestion request;
a charging facility search unit configured to search for charging facilities located within a predetermined range from a position of the vehicle among the charging facilities based on the position information of the vehicle included in the suggestion request information;
an incentive information creation unit configured to create, based on the charging facility information pertaining to charging facilities found by the charging facility search unit and the battery capacity information of the vehicle corresponding to the identification information of the vehicle, incentive information of each of the found charging facilities for the vehicle; and
an incentive information output unit configured to transmit the charging facility information and the incentive information to the vehicle or the terminal of the user of the vehicle.

2. The charging facility suggestion device according to claim 1, wherein
upon receiving the charging facility suggestion request from two or more of the vehicles or terminals of users of the vehicles, the incentive information creation unit creates incentive information so as to benefit a vehicle having a smaller battery capacity according to the battery capacity indicated by the battery capacity information of each vehicle.

3. The charging facility suggestion device according to claim 1, wherein
the incentive information creation unit creates the incentive information as a priority reservation for the charging facility or a discount on a unit charging price.

4. The charging facility suggestion device according to claim 1, wherein the charging facility information in the map information storage includes charging speed information of the charging facilities, and
the incentive information creation unit creates the incentive information for any of the charging facilities that has charging speed information indicating a lower charging speed than a predetermined value.

5. A charging facility suggestion method for suggesting a charging facility, the charging facility suggestion method comprising implementation by a computer of:
a map information storage step of storing charging facility information pertaining to charging facilities for charging vehicles;
a vehicle information storage step of storing identification information and battery capacity information of a plurality of vehicles;
a suggestion request input step of receiving, from a vehicle included in the plurality of vehicles or a terminal of a user of the vehicle, suggestion request information including position information of the vehicle and a charging facility suggestion request;
a charging facility search step of searching for charging facilities located within a predetermined range from a position of the vehicle among the charging facilities based on the position information of the vehicle included in the suggestion request information;
an incentive information creation step of creating, based on the charging facility information pertaining to charging facilities found in the charging facility search step and the battery capacity information of the vehicle corresponding to the identification information of the vehicle, Incentive information of each of the found charging facilities for the vehicle;
an incentive information output step of transmitting the charging facility information and the incentive information to the vehicle or the terminal of the user of the vehicle.
